(19) United States
(12) Patent Application Publication
(10) Pub. No.: US 2009/0244402 A1
(43) Pub. Date: Oct. 1, 2009

(54) FAVORITE CHANNEL REMOTE

(76) Inventors: David J. Rye, Kent, WA (US); James R. Phillips, Bellevue, WA (US); George E. Stevenson, Kowloon (HK)

Correspondence Address: BLACK LOWE & GRAHAM, PLLC, 701 FIFTH AVENUE, SUITE 4800, SEATTLE, WA, 98104, US

(21) Appl. No.: 12/139,312

(22) Filed: Jun. 13, 2008

Related U.S. Application Data
(63) Continuation-in-part of application No. 11/832,542, filed on Aug. 1, 2007.
Application No. 11/832,542 is a continuation-in-part of application No. 11/615,881, filed on Dec. 22, 2006.
Application No. 11/615,881 is a continuation-in-part of application No. 11/552,924, filed on Oct. 25, 2006.
(60) Provisional application No. 60/806,254, filed on Jun. 29, 2006.

(51) Int. Cl. H04N 5/44

(52) U.S. Cl. 348/734; 348/E05.096

(57) ABSTRACT

A remote control and method of using the remote control are provided. The remote control includes a microprocessor, a memory accessible by the microprocessor that includes a database of a plurality of favorite channels, a user interface in signal communication with the microprocessor that allows selection of successive next or previous favorite channels, and a transmitter controlled by the microprocessor that, responsive to user activation of the user interface, transmits wireless signals corresponding to the successive next or previous favorite channel. In an example embodiment, an icon is associated with each favorite channel and the remote includes a display screen that displays the icon associated with the successive next or previous favorite channel when the user interface is activated. The method of using the remote control includes activating the user interface to select a next favorite channel.

### PRIORITY CLAIM

This application is a continuation-in-part of U.S. patent application Ser. No. 11/832,542 filed on Aug. 1, 2007 and is also a continuation-in-part of U.S. patent application Ser. No. 11/615,881 filed on Dec. 22, 2006, both of which are continuation-in-part applications of U.S. patent application Ser. No. 11/552,924, filed on Oct. 25, 2006, which claims priority to U.S. Provisional Application Serial No. 60/806,254 filed on Jun. 29, 2006, all of which are hereby incorporated by reference in their entirety.

### FIELD OF THE INVENTION

This invention relates generally to a programmable remote control and, specifically, to a programmable remote control with selective setup features.

### BACKGROUND OF THE INVENTION

One of the pervasive features of consumer audio and video electronic components in recent years has been and continues to be the handheld remote control. The handheld remote control sends control signals to the controlled media device, generally using either infrared or radio frequency signals. The remote control signal may alter any of a variety of aspects of the electronic device being controlled, such as its volume, channel, power, or various performance settings such as color, contrast, tint, or others.

Most conventional television remotes typically have a plurality of buttons with preassigned functions. For example, remotes commonly have a number pad with a button assigned to each number 0 through 9. They also generally include buttons to increase or decrease the current channel number, increase or decrease the volume setting, and to invoke a menu-driven on-screen selection for adjusting picture attributes such as color, contrast, or tint. These standard remotes offer little functionality and require users to independently memorize various settings and channels.

In some cases, remotes include keys that can be programmed. One method for inputting, downloading, or otherwise programming the desired functions of the remote control includes entering such commands directly on the remote control as taught by U.S. Pat. No. 5,414,426. Most such remote controls can only store commands if those commands are present in a code library contained within the remote control.

Consequently, there is need for an improved programmable remote control that provides better features than found in the prior art remotes.

### SUMMARY OF THE INVENTION

The present invention is an improved remote control, preferably including a remote control that can control a television. Alternate examples of the invention include a system for programming the remote control and various methods of programming and using the remote control. In one example, the remote control is configured to be selectively set up or programmed, which allows a user to set up only the specific remote control features of interest. The remote control may include a module that may be accessed directly by the remote control or via a computer to guide the user through the set up process. If this feature is included and used by the user, it enables the user to avoid setting up undesired features, thereby saving the user time by not answering many questions and options that would otherwise be necessary if a full set up were required.

In one example of the invention, a remote control includes a memory, a microprocessor, and a display screen sized to display a plurality of icons. Depending on the tailored implementation by the user, one or more of the icons corresponds to a channel of a media device such as a television. Buttons may be included to enable selection of any of the plurality of icons when the remote control is in a select-channel mode. In one example, the selection of the at least one of the plurality of icons activates an assigned function stored by the memory device in the remote control. The remote further includes a transmitter arranged in the remote control to transmit a wireless signal from the remote control toward a media device. The remote may include an infrared transmitter, a radio frequency transmitter, or both.

In another example of the invention, a system includes a remote control having a display screen that is generally similar (but not necessarily identical) to the exemplary remote discussed above. In addition, a computer is programmed such that it is in communication with the remote, either wired or wirelessly, as desired. The communication link enables the personal computer to send a variety of signals to the remote, for example including updates for channel or other icons to be displayed on the screen or for channel assignments correlating channel icons with particular television channels.

In another example of the invention, the remote is in communication with a computer to receive signals not necessarily related to the control of the television or other remotely controlled device. For example, many security devices are configured for communication with a home computer. In turn, the home computer is programmed to send an appropriate signal to the remote, causing the remote to display an applicable message or iconic representation on the screen representative of a condition in the security device.

In yet another example of the invention, a remote control includes a plurality of favorite channel buttons, an icon holding member having at least one surface positioned adjacent to at least one of the favorite channel buttons, and a transmitter that transmits signals, such as a channel corresponding to an icon located on the icon holding member, to a media device in response to a favorite channel button being pressed by a user.

In still another example of the invention, a method of configuring a remote control having a plurality of favorite channel buttons, an icon holding member having at least one surface adjacent to at least one of the favorite channel buttons, and a transmitter is provided. The method of configuring the remote control includes placing an icon on the icon holding member adjacent to one of the favorite channel buttons and programming the remote control to send a signal representing a desired channel that corresponds to the icon using the transmitter when the favorite channel button adjacent to the icon is pressed.

In an additional example of the invention, the remote control includes a user interface configured to allow selection of successive next favorite channels in a previously stored database of a plurality of favorite channels.

In a further example of the invention, the user interface is also configured to allow selection of successive previous favorite channels in the database of favorite channels.

In still an additional example of the invention, the remote control includes a display screen that is configured to display an icon corresponding to the successive next or previous favorite channel when the user interface is activated by a user to change channels to the successive next or previous favorite channel.

In some examples, the remote includes a dedicated favorite channel up and a dedicated favorite channel down button, the dedicated buttons being configured to change the channel of the television or other media device to the next favorite channel from the list of stored favorite channels. In this fashion, the remote is able to sequence through the favorite channels in a desired order, skipping over intermediate channels.

In yet another example of the invention, the remote control includes a first multipurpose button configured as a favorite channel up button and a second multipurpose button configured as a favorite channel down button, wherein the first multipurpose button is a channel up button that cycles up through all channels when not otherwise configured, and wherein the second multipurpose button is a channel down button that cycles down through all channels when not otherwise configured.

In still another example of the invention, the remote control includes a dedicated favorite channel up button and a dedicated favorite channel down button.

In a further example of the invention, the favorite channel up button and the favorite channel down button cycle through the favorite channels in the same order in which their corresponding icons are positioned in an icon holding member on the remote control.

In an additional example of the invention, a method of using the remote control with a media device includes activating the user interface to select a next or a previous favorite channel from the database of favorite channels.

### BRIEF DESCRIPTION OF THE DRAWINGS

The sizes and relative positions of elements in the drawings or images may not necessarily be to scale. For example, some elements may be arbitrarily enlarged or otherwise modified to improve clarity. Further, the illustrated shapes of the elements may not convey their actual shapes, and have been solely selected for ease of recognition. Various embodiments are briefly described with reference to the following drawings:

FIG. 1 is a schematic view of a system comprising a computer in communication with a remote control according to one illustrated embodiment;

FIG. 2 is a system diagram of the remote control of FIG. 1;

FIG. 3 is an isometric view of a remote control sending a wireless signal to a media device according to one illustrated embodiment;

FIG. 4A is a top plan view of a remote control having a display screen showing a number of menu items according to one illustrated embodiment;

FIG. 4B is an isometric view of a removable faceplate attachable to the remote control of FIG. 4A;

FIG. 5A is a top plan view of a remote control showing an operational association between a number of peripheral buttons and a display screen according to one illustrated embodiment;

FIG. 5B is a top plan view of the display screen of the remote control of FIG. 5A showing a number of generic shapes that represent icons according to one illustrated embodiment;

FIG. 6A is top plan view of a remote control having various menu items for setting up the remote control displayed on a display screen;

FIG. 6B is the remote control of FIG. 6A showing a number of users, user groups, or topical groups containing customized icon/channel pairings;

FIG. 7A is a flowchart showing a method of setting up a remote control, to include inputting geographic reference information, according to one illustrated embodiment;

FIGS. 7B-7G show a top plan view of a display screen of a remote control with menus for proceeding through the method provided in FIG. 7A;

FIG. 8A is a flowchart showing a method of setting up a media device to be controlled by a remote control according to one illustrated embodiment;

FIGS. 8B-8E show a top plan view of a display screen of a remote control with menus for proceeding through the method provided in FIG. 8A;

FIG. 9 is a flowchart showing similar, but slightly different methods for arranging channel number and icon pairings in a remote control;

FIG. 10 is a flowchart showing a method of setting up a protection or restriction feature on a remote control;

FIG. 11 is a flowchart showing a method where a remote control is communicates with a home security system;

FIG. 12 is a top plan view of a remote control in accordance with an embodiment of the invention;

FIG. 13 is a perspective view of the remote control of FIG. 12 showing a view with an open icon holding member cover; and

FIG. 14 shows a group of channel icons or logos.

### DETAILED DESCRIPTION OF THE INVENTION

One preferred example of the invention takes the form of a remote control having a display screen configured to display a number of menu items. For example, the screen may be able to display icons that represent particular channels of a media device, such as the channels of a television as provided by a particular cable television provider within a specific geographic region. The display screen may be configured to present color versions of the icons, where the icons are logos that identify a particular network channel, such as a television (local or other), cable, satellite, radio, or other media device channel. In this example, a user is able to change the channel on the television by selecting an icon that is visible or at least accessible on the display screen (i.e., scroll up, down, left, right on the screen to access additional icons). The user may select the icon by touching it on the screen or by pressing an associated button adjacent to the screen rather than one of the conventional methods of selecting a channel which may include selecting and then scrolling through a channel guide displayed on the television screen or memorizing favorite channels and entering numbers on a keypad to switch between or go to those favorite channels. As many remote control users appreciate, if the channel numbers are not entered quickly then the desired channel is not selected.

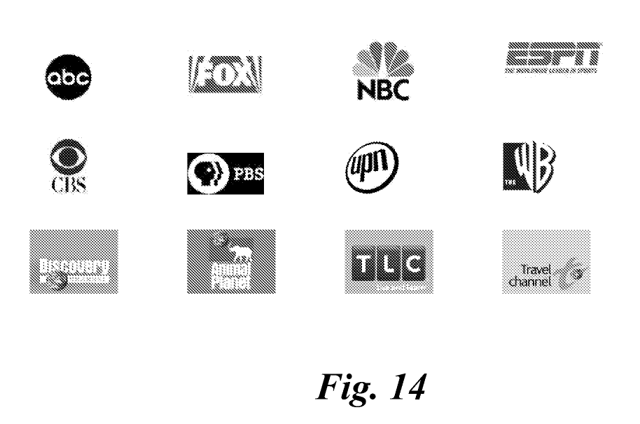

In one embodiment of the invention, the remote control is programmable by direct interaction, which is accomplished using the display screen, using a keypad, using function keys or buttons, or some combination of the above. In one example, the remote control is preprogrammed with a collection of icons representative of network channels. The icons may be associated with particular television channels or, alternatively, may be unassigned. The icons may be in various forms such as text, image, or a combination of both. In addition, the icons may represent trademarked logos for particular media distributors (e.g., ABC®, CNN®, HBO®, ESPN®, etc.). A group of channel icons or logos, which may be available in the United States, is shown for illustrative purposes in FIG. 14 and is not meant to be an all-inclusive listing.

The association of an icon with a particular television channel number may depend on a specific geographical region where the television is located, a particular service provider, or both. A single channel, for example the American Broadcast Company, ABC®, may be associated with different channel numbers in different regions of the United States because one provider on the West Coast may assign channel “4” to ABC while a different provider on the East Coast assigns channel “7” to ABC. Accordingly, the remote control may be purchased with a pre-assigned, stored icon/number database for a geographic region specified by a user upon ordering the remote control or the remote control may be programmed by the user after purchase. In one embodiment, the association of the icons with the channels numbers in accordance with a particular geographic region includes entering a postal zip code into the remote control.

In addition to assigning all or any subset of the available icons to particular media device channels, the remote control may be configured to operate a variety of media devices. Various methods of configuring the remote control for desired media devices and favorite media device channels are discussed in greater detail below. In addition, any of the keys or icons may be programmed to carry out a variety of commands. One example of storing and executing macro commands via a remote control is described in U.S. Pat. No. 6,998,997, which is incorporated by reference. In one example of the present invention, the remote control includes the ability to store and execute macro commands as described in the '997 patent, with one or more macro commands being triggered by touching an icon displayed on the display screen or pressing an option button located adjacent to the screen.

In one embodiment, the remote control is programmable using a wired or wireless data communications link between the remote control and a computer. The computer includes software that permits the user to customize features of the remote control and then download or transmit those features to the remote control. The remote control is selectively programmable, which means the user can choose to program or set up certain aspects of the remote control while skipping over other setup menus or leaving certain aspects of the remote control in a default or in a non-programmed configuration.

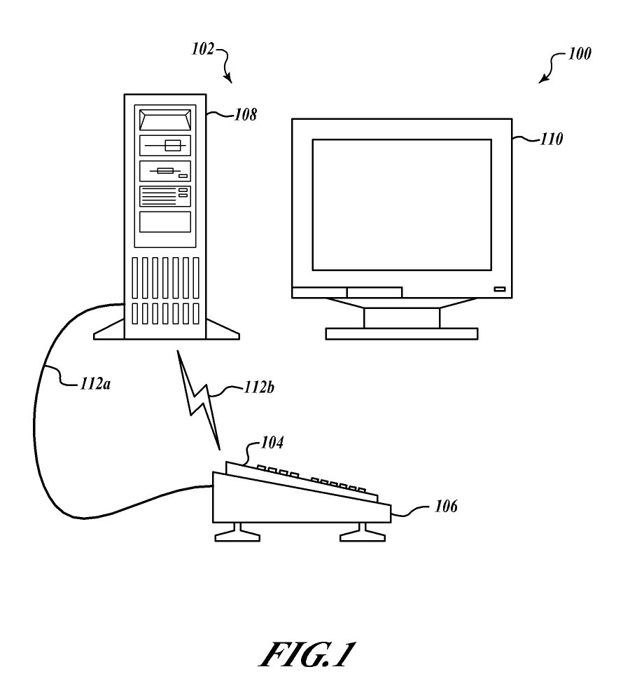

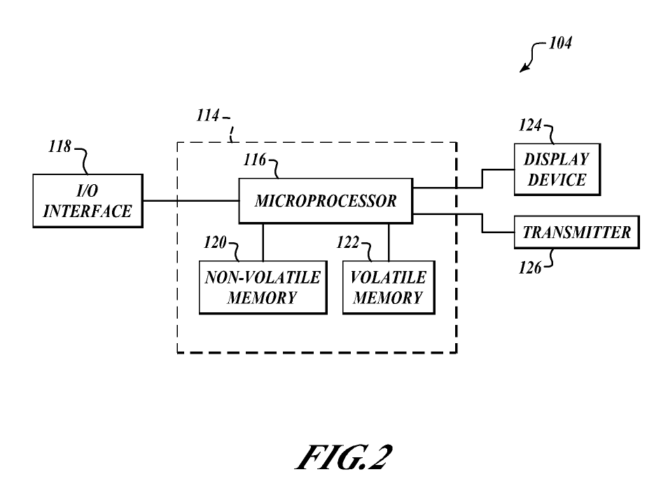

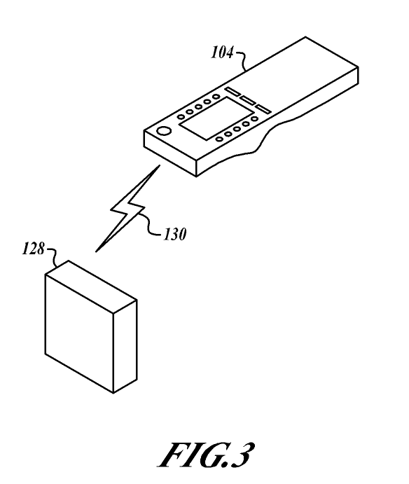

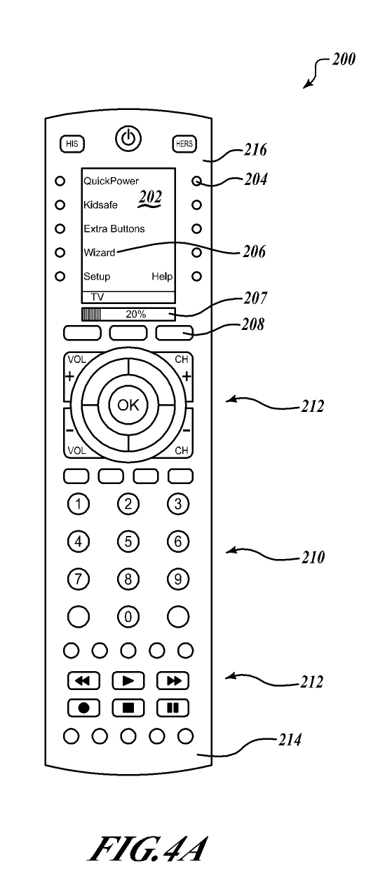

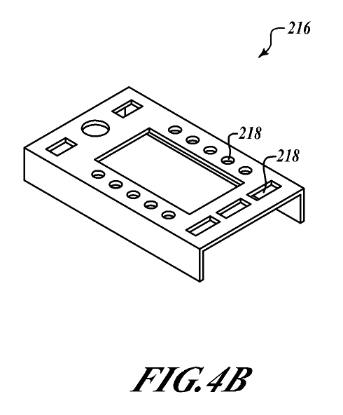

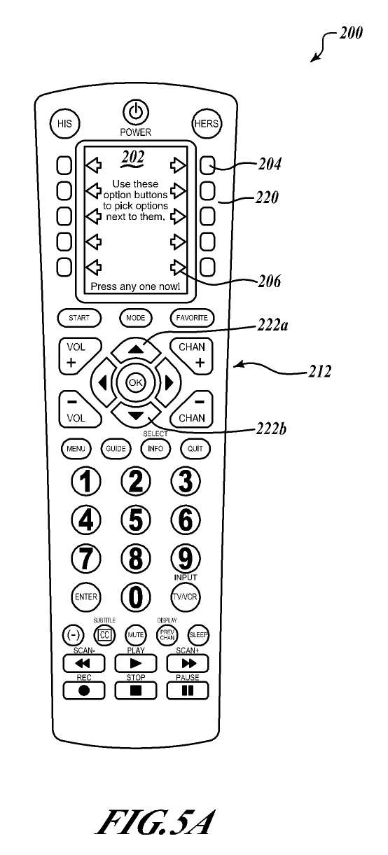

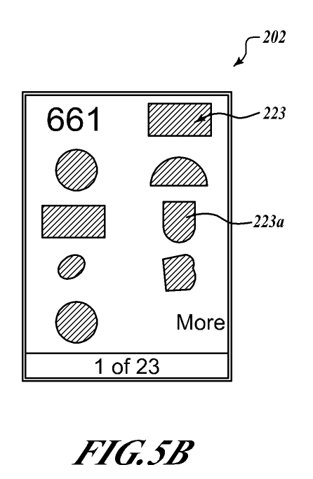

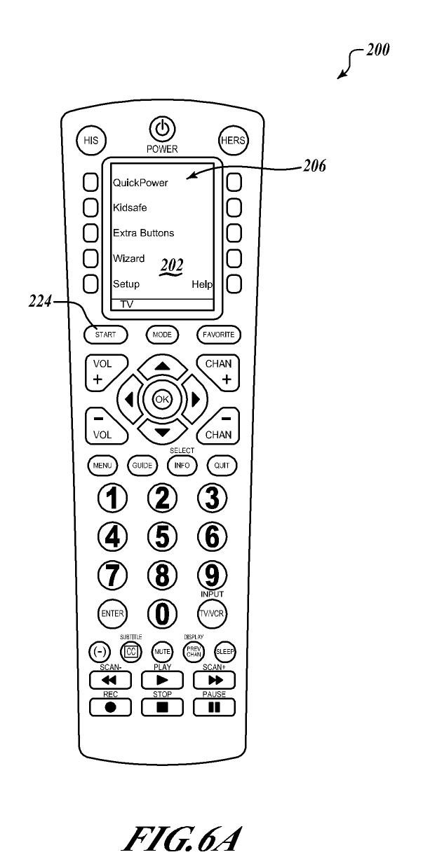

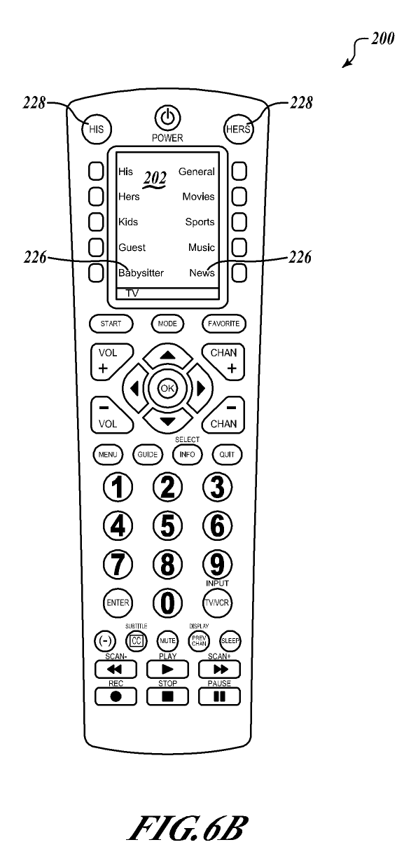

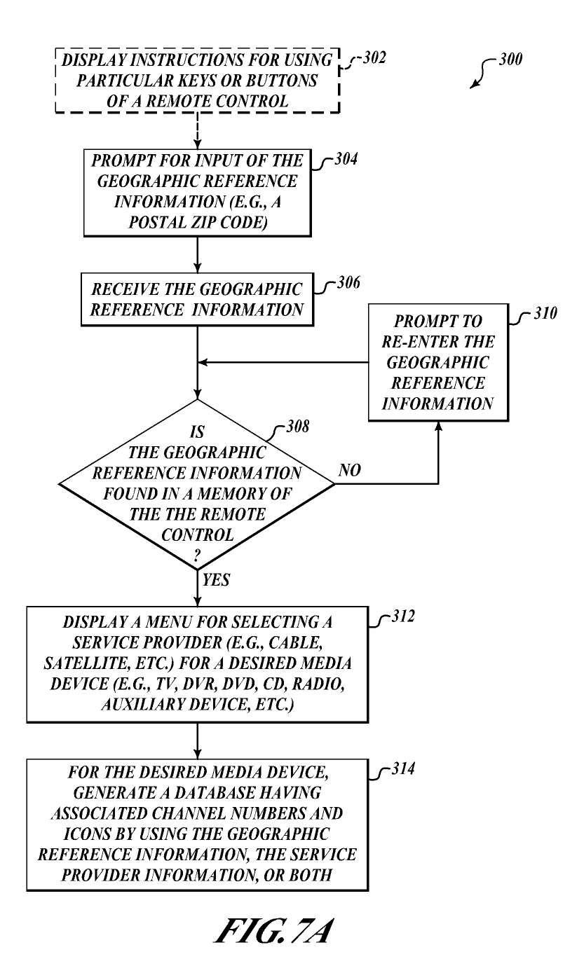

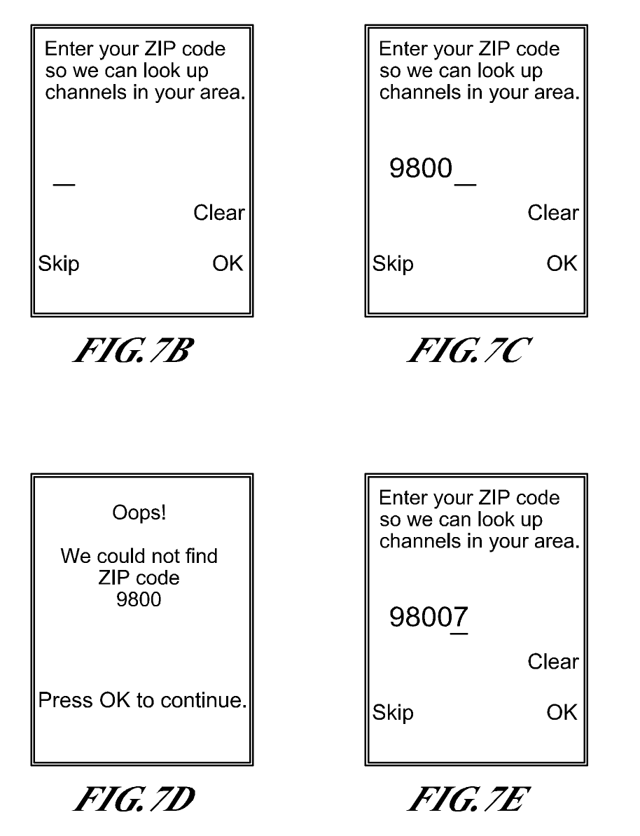

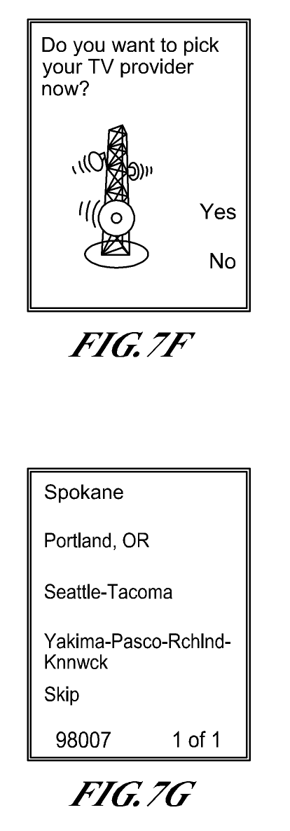

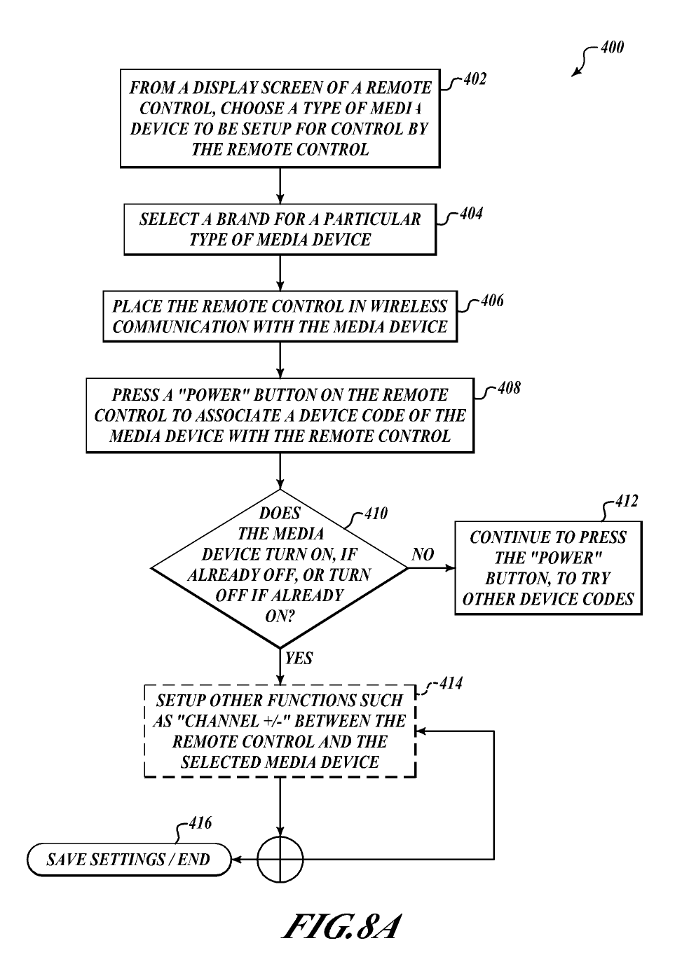

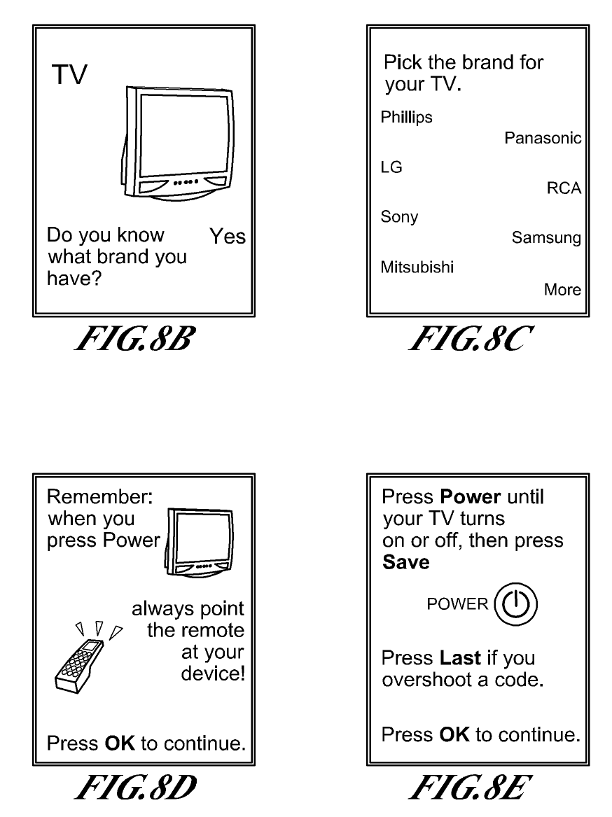

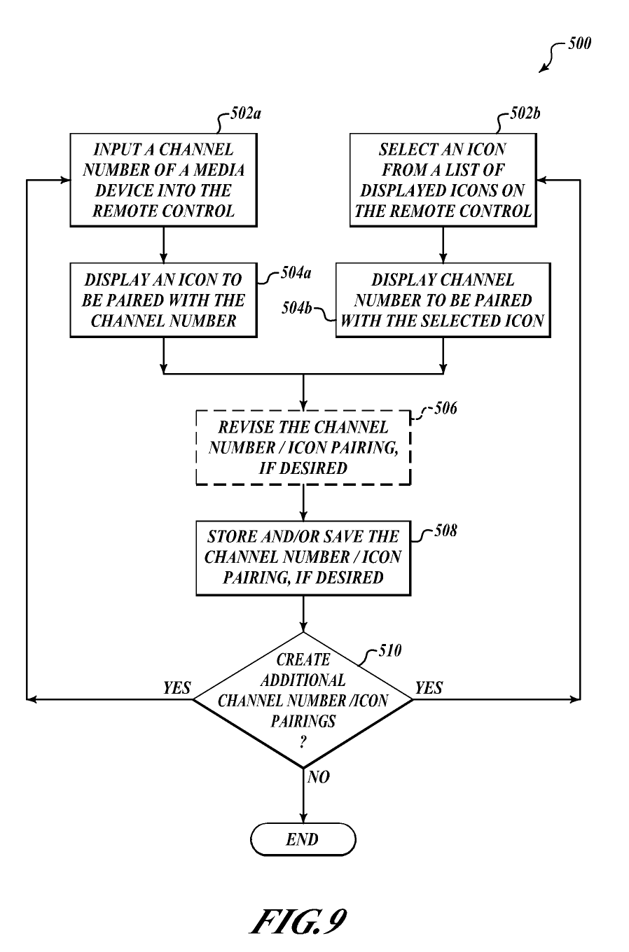

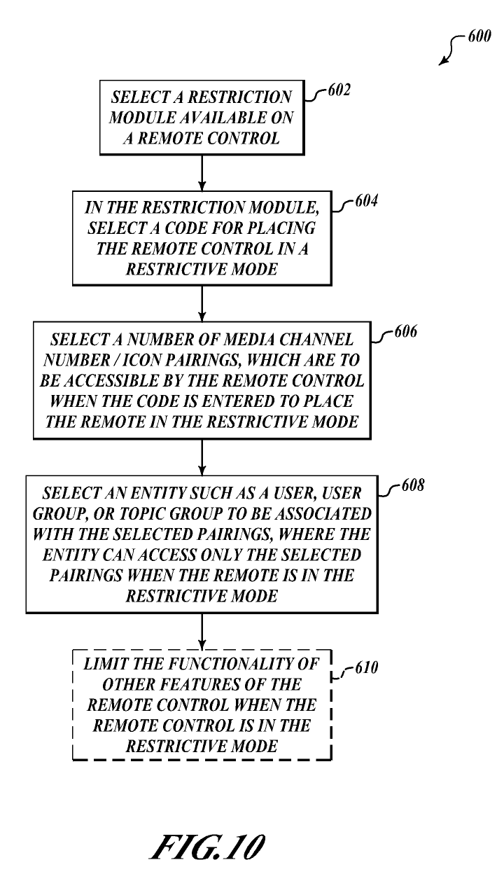

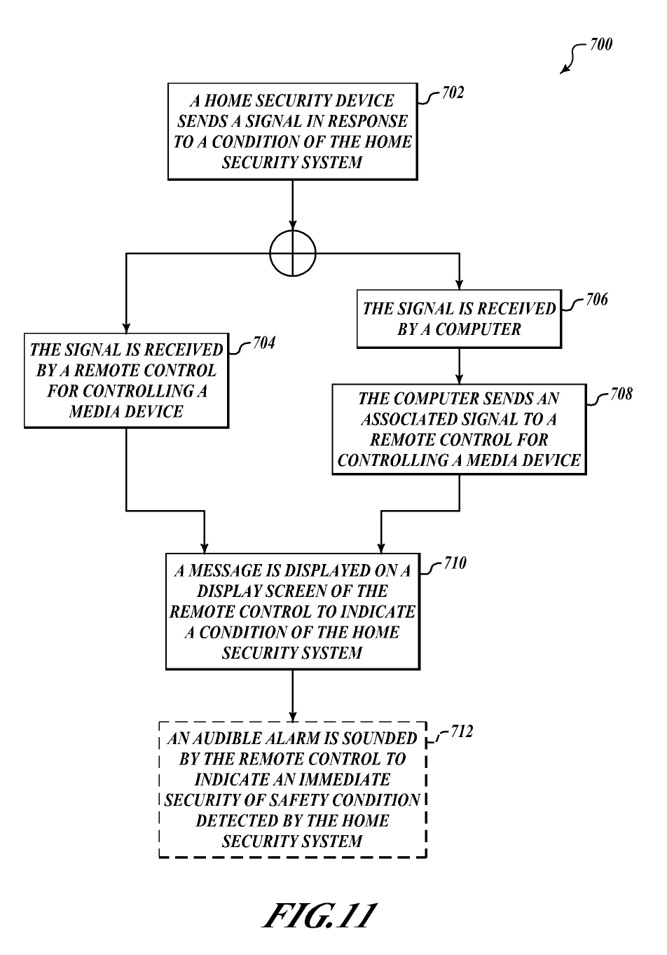

FIG. 1 shows a system 100 comprising a computer 102, a remote control 104, and a docking station 106, according to one illustrated embodiment of the present invention. The computer 102 includes a central processing unit (CPU) 108 with a memory, a monitor 110, and may include a number of user interface devices (not shown) such as keyboard, mouse, joystick or other devices to provide for local user interaction with the computer 102. Local user interaction may include, but is not limited to, configuring the system, loading and monitoring media content, downloading data to the computer 102 or to the remote control 104, adjusting operational parameters, and performing other functions.

In one embodiment of the invention, the computer 102 is employed to set up or program the remote control 104. For example, icons corresponding to channels potentially available on a user's television are downloaded onto the computer 102 over a network, such as the Internet. These downloaded icons are then transferred to the remote control 104 via the connection between the computer 102 and the docking station 106. The network connection with the computer 102 allows for further updating information stored in the remote control 104, which may include, but is not limited to, downloading new icons, revising existing, stored icons, reconfiguring the remote control 104 for use in a different geographic region, adding to or revising a database of media device codes stored in the remote control, etc.

While these actions may be performed using the computer 102, the invention also provides that these actions can be accomplished without the computer 102. As will be described in greater detail below, the process of setting up or programming the remote control 104 may be done directly through various input/output (I/O) interfaces arranged on the remote control 104 and which may also include selecting menu items visually displayed on the remote control 104. In one embodiment, the process of setting up or programming the remote control 104 is accomplished with a cellular telephone (not shown) in a manner that is similar to downloading a ringtone or a digital photo.

The docking station 106 is preferably coupled to the computer by a wired connection 112a. Additionally or alternatively, the communication between the computer 102 and remote 104 may be a wireless connection 112b, and may not require the docking station 106. By way of example, a wireless connection 112b can be via BLUETOOTH®, radio frequency (RF), infrared (IR), or other means. The wired connection 112a may be via a serial, USB, FIREWIRE®, or other cable received in appropriate ports (not shown) of the computer 102 and the docking station 106. The docking station 106 preferably includes a power connection to the remote 104 so that rechargeable batteries in the remote control 104 may be recharged when the remote 102 is electrically coupled with the docking station 106. Optionally, the remote 104 may connect directly to the computer 102 via the wired connection 112a or the wireless connection 112b to modify remote settings.

FIG. 2 shows the remote control 104 having a microprocessor 116 coupled to receive input from an I/O interface 118, which may be a keyboard, a touch screen, or some other mechanism for triggering action by the microprocessor 116. In one embodiment, a combined processor and memory 114 further includes a first memory 120, which is a nonvolatile memory that preferably stores operating system instructions for the microprocessor 116, and may take the form of memory devices such as read-only memory (ROM), programmable read-only memory (PROM), electrically programmable read-only memory (EPROM), or electrically erasable programmable read-only memory (EEPROM). In another embodiment, a second memory 122 is provided, which may be a volatile memory such as random access memory (RAM), for temporarily storing signals that form program or macro routines until those routines are saved in the nonvolatile memory 120. However, the program or macro routines can be permanently saved in the second memory 122.

In one embodiment, the remote control 104 includes batteries that provide electrical power to the remote control 104 further provide power to the first memory 120 or the second memory 122. A capacitor (not shown) provides backup power to the memories 120, 122 while the batteries are being changed or charged. In an alternative embodiment, an EEPROM is used in lieu of the capacitor.

The remote control 104 further includes a display device 124 and a transmitter 126. The display device 124 receives input signals under control of the microprocessor 116 and displays information to the user. The transmitter 126 receives electronic signals from the microprocessor 116. In one embodiment, the transmitter 126 is an optical transmitter that cooperates with the microprocessor 116 to perform an electro-optical conversion of the electronic signals to optical signals for transmission to a media device 128 (FIG. 3).

FIG. 3 shows the remote control 104 in communication with the media device 128 such as a television via a wireless signal 130 according to one illustrated embodiment of the invention. The media device 128 may take the form of any of a variety of devices, such as a television (TV), a cable box, a video cassette recorder (VCR), a digital video disk (DVD) player, an audio amplifier, a radio receiver or tuner, a compact disk (CD) player or recorder, a digital video recorder (DVR), or other media devices. Hereinafter and throughout this description, the media device 128 will generally be referred to as the TV for brevity and clarity. Thus, a command to change the channel of the media device 128 using an icon displayed on the display screen of the remote control 104 comprises sending the command from the remote control the TV either directly or through another device such as a television tuner on a VCR, a cable box, a satellite box, or a set-top box.

The commands issued by the remote may be a simple instruction such as the command to change a channel. Alternatively, one command may issue multiple instructions such that the remote control 104 operates to turn on the cable box, turn on the television, select a particular channel, and set the volume to a desired level. In accordance with a preferred implementation of the invention, the remote control 104 includes programming instructions stored in at least the first memory 120 and executable by the microprocessor 116 to assign a sequence of command instructions, referred to as a macro, to a button or icon for controlling the remotely controlled media device 128. The components of a remote 104 capable of carrying out such macros are described in the aforementioned '997 patent.

FIG. 4A shows an exemplary remote control 200 having a display screen 202, first peripheral keys or buttons 204 that correspond to menu items 206, second buttons 208, a numeric keypad 210, and other input interfaces 212 according to the illustrated embodiment. The overall layout of the remote 200 may be arranged in any number of ways, for example the display screen 202 may be placed in the middle of the remote or the numeric keypad 210 may be located directly below the second buttons 208. The other input interfaces 212 may correspond to depressible buttons, such as play, stop, fast-forward, rewind, mute, channel+, channel−, volume+, and volume−. In one embodiment, an exterior surface 214 is made from a chemically etched metallic alloy permitting each button or key to be subtly illuminated. In addition, the display screen 202 may be active or lit most of the time, which may require low levels of power to be drawn from rechargeable batteries (not shown) in the remote control 200. During various operations of the remote control, a status bar 207 indicates the progress of the operation, for example receiving or transmitting data.

FIG. 4B shows a removable faceplate 216 with openings 218 corresponding to the buttons on the remote control 200. The removable faceplate 216 may be sized to fit over a portion of the remote control 200 or over the entire front, exterior surface 214 of the remote control 200. In a preferred implementation, a pip or pin (not shown) extending from the faceplate 216 is received by a small, corresponding opening hole on the remote control 200 when the faceplate 216 is placed on the remote control 200. The pip or pin makes contact with a printed circuit board (PCB) in the remote control 200 to activate the “His” or “Hers” mode, for example. By using the pip or pin, the faceplate converts the remote to one tailored to a particular individual. Alternative methods for enabling the faceplate to tailor the device are also possible.

The display screen 202 may take various forms such as a liquid crystal display (LCD), a light emitting diode (LED) display, a thin film transistor (TFT) display, or a touch screen. In one embodiment, the display screen 202 includes a status bar indicator (not shown) to indicate downloading, uploading, or data transferring progress while the remote control 200 is being directly programmed or is in communication with the computer 102. During initial setup of the remote control 200, the display screen 202 may optionally display the icon of a vendor, such as a cable company or the store where the remote control 200 was purchased (e.g., Wal-Mart, K-Mart, Target, etc.). In addition, such a vendor icon may be displayed during initial power up after the batteries are inserted into the remote control 200.

FIG. 5A shows the peripheral buttons 204 positioned on a left/right perimeter region 220 adjacent to the display screen 202. Each button 204 corresponds to a menu item or icon 206 represented on the screen 202. The peripheral buttons 204 are used to select the associated menu item 206; various aspects, features, and functionality of the peripheral buttons 204 will be apparent in the description provided below. In the example of the invention incorporating a touch screen, the peripheral buttons 204 may optionally be omitted because the menu items 206 may be selected by touching them directly on the screen 202 rather than by pressing one of the peripheral buttons 204.

In the illustrated embodiment, the peripheral buttons 204 comprise ten user-defined buttons associated with the menu items 206. In the event the remote control 200 contains more menu items 206 than buttons 204, the remote control 200 may have a scroll mechanism, such as the up/down buttons 222a, 222b shown in the illustrated embodiment. Alternatively, the scroll mechanism may comprise a scroll wheel or other similar mechanism. The scroll mechanism 222 permits the user to scroll among menu items 206 that are not presently visible on the display screen 202. In such a case, scrolling down would cause menu items 206 to successively move up the screen 202 such that the menu items at the top of the screen would drop off and move out of view while new menu items appear at the bottom of the screen and continue to move upward as long as the scrolling instruction is maintained. Scrolling up causes the opposite movement of the menu items 206.

As best seen in FIG. 5B, exemplary icons 223 are illustrated as generic shapes on the display screen 202. The generic shapes 223 represent actual logos and brands, which may be in various forms such as text, image, or a combination of both. By way of example, the actual logos may be trademarks of a particular media distributor (e.g., ABC®, CNN®, HBO®, FOX®, etc.). Thus, once the remote has been programmed to associate an icon with a channel, depressing the peripheral button 204 adjacent the icon will cause the channel to change to the channel associated with the icon. Programming instructions stored in the remote control's memory are associated with each icon. For icons indicative of a television channel, the memory stores data sufficient to cause the remote control to send a signal to the television to change to the channel represented by the icon. Other icons may represent aspects other than channels, and instructions stored in the memory reflect the function desired to be carried by the icons. For example, depressing the button adjacent to a first icon 223a will change the television channel to whatever channel is assigned to the first icon 223a. The same result will occur in a touch screen version by touching the icon itself. Likewise, if the remote has further macro programming assigned to the icon, touching the icon or the adjacent button causes the remote to carry out the macro instructions assigned to the icon.

In some examples of the invention, the remote control 200 is capable of downloading additional icons 223 via the computer 102. The icons 223 are then transferable to the remote control 200 and can be added as channel favorites. When personalized with the user's favorite channels (e.g., his, hers, or kids), the icons 223 will be displayed in the screen 202 next to the buttons 204. Pressing an associated button 204 will send a sequence of commands to change to that channel of the media device, for example pressing the button 204 next to an ABC® icon (not shown) changes the television channel from the present channel to ABC®. In one embodiment, the computer 102 includes a configuration utility that allows multiple users to be assigned to the remote control 200 where each user will have the ability to assign up to ten favorite buttons 204 (or more depending on memory limitations). In an alternative embodiment, a single user may assign any number of favorite channels and scroll through these favorites on the display screen 202. These features and other aspects of the remote control 200 are described in additional detail below.

The assignment of icons (or buttons) to particular channels can be made directly on the remote by following menu-driven setup instructions presented on the screen. Alternatively, as discussed above, the remote setup including channel assignments can be performed on a home computer and then transferred to the remote. If the computer 102 includes an Internet connection, software accompanying the remote and operable by the computer may access a remote server containing a database of icons and channel associations. By accessing the remote server, a user can download the channel associations for the user's area (or that have been assigned by the user's television service provider). In one example, the software operating on the computer requests user information such as the user's zip code or phone number, then accesses the remote server to determine the appropriate channels associated with the desired icons for the entered zip code or phone number. The channel associations are then downloaded to the personal computer and transferred to the remote. In a similar fashion, the remote server may store sets of macro commands that can be downloaded and transferred to the remote control.

FIG. 6A shows one exemplary embodiment of the display screen 202 of the remote control 200 having a number of menu items 206 that may be used to program or operate the remote control 200. In one embodiment, these menu items 206 are presented on the display screen 202 when the “START” button 224 is depressed. Generally, the menu items 206 permit different features or aspects of the remote control 200 to be accessed. By way of example, the remote control 200 is programmable or operable to control selected devices, provide quick access to a group of favorite media device channels, and limit or restrict use of the remote control 200 when the remote control 200 is being used by a particular user, such as a child. In addition, the remote control 200 may communicate and operate with a home security system, with a computer, or another remote control, which may include the remote control 200 transferring data to/from the other remote control.

FIG. 6B shows one example of the remote control 200 personalized for multiple users (e.g., his, hers, child, babysitter, etc.) or customized for a particular category of channels (e.g., news, sports, movies, music, etc.). In this example, various users, user groups, or category or topical groups 226 may each be assigned a number of favorite channels. Setting up the remote control 200 to have desired, favorite channels is described in greater detail below.

Any number of users may share a common remote control in this fashion, using a scrolling function to scroll the listed users or user groups 226 up and down as necessary until a desired user or group is found. By pressing the button (or touching the screen) associated with a user or group 226, programming within the remote control causes the favorite channels (i.e., icons, logos, or alphanumeric characters) associated with that user or group 226 to be displayed on the display screen 202. Likewise, the memory stores data files associated with each user group or category, defining the stored icons and channels or actions desired to be contained in that group. For example, one user may favor all sports channels and tailors the remote control to place those icons prominently at the top of the display. Another user may prefer movie channels and may tailor the remote to place those channel icons at the top of the display. By selecting the appropriate group 226, the display is quickly tailored to the preferences of the user.

In the illustrated embodiment, the remote control 200 includes buttons 228, identified as a “His” and a “Hers” buttons for example, that allows the remote control 200 to be quickly reconfigured for either him or her. This “his and her” example is an alternate form of the personalization described above and is ideally suited, for example, for use by a couple. In this form, pressing the “Her” button 228 on the remote control will set the remote control to display her favorite channels on the display screen 202.

In some embodiments, the remote control 200 is configured to allow a user to successively step through their favorite channels for the media device 128 rather than being required to step through all available channels as is the case with typical channel up/channel down buttons. In an example embodiment, a plurality of favorite channels for one or more users are stored in a database contained in at least one of the first memory 120 and the second memory 122, such as is described above. Each user may have a tailored list of favorite channels stored in the database. A user interface that allows the user to step up or down through their favorite channels is implemented in different ways in various embodiments. Activation of the user interface causes the transmitter 126 to send a wireless signal sufficient to cause a channel of the media device 128 to change to a next successive favorite channel or a previous successive favorite channel.

Note that as used here “next successive” favorite channel does not necessarily mean the next higher or lower channel number that happens to be a favorite. Though that is the case in some examples of the invention, in other versions the favorite channels are organized as desired by the user. For example, the sports channels may be numbered channel 4, 31, 37, and 99. Favorite movie channels may be channel numbers 13, 33, and 40. If all of these channels are stored in a favorite channel listing, the favorite channel up button may proceed numerically from channel 4, next to channel 13, then to channel 31, and so on. Alternatively, the favorites may be stored in like groups, such that the channel up button will cause the channels to change from 4 to 31 to 37 to 99, and then to 13 to 33 and to 40. Thus, the sequence of the channel up and channel down progression may be in accordance with the manner in which the favorites are stored, allowing the user cycle through all of a common grouping of channels together.

A dedicated favorite channel up button and a dedicated favorite channel down button are included on the remote control 200 in some embodiments that may take the place of or be in addition to the buttons shown in the other embodiments. Referring to FIG. 4A, the button to the left of the zero number button on the remote control 200 may be configured to be the dedicated favorite channel down button and the button to the right of the zero number button may be configured to be the dedicated favorite channel up button in an example embodiment. In such an embodiment, the remote includes both standard channel up/down buttons and favorite channel up/down buttons. Preferably, the favorite channel up and down buttons cycle through the list of favorite channels in a circular fashion, such that the next favorite channel after the last channel in the stored favorite channel database is the first channel and the previous favorite channel before the first channel is the last channel.

In other embodiments, some buttons on the remote control 200 are multi-function buttons, with a function that may be specified by the user. The specified function may be context specific, or may operate at all times until changed. In some embodiments, such as the embodiment shown in FIG. 6B, the user can change the functionality of the channel up (CHAN +) button and the channel down (CHAN −) button on the remote control 200 so that the channel up and channel down buttons will successively step to the next favorite channel and the previous favorite channel, respectively, when pressed rather than stepping through all available channels. In some embodiments, the display screen 202 displays an icon associated with the successive next or previous favorite channel when the channel up or channel down button is pressed.

The user interface may also include a touch screen instead of or in addition to physical buttons. In one example of such an embodiment, the favorite channel up/down buttons may be displayed directly on the touch screen. Likewise, the screen may display an icon associated with the current channel and icons associated with the next higher and next lower favorite channels. Touching the next higher (or lower) icon causes the remote to send a signal to change the media device to that channel, then advances the display on the remote touch screen to again display the current, next higher, and next lower icons.

The remote control 200 is also a mobile phone in some embodiments. With a mobile phone remote control, the user interface may use portions of a standard mobile phone user interface to control favorite channel up and favorite channel down functionality.

The programming and setting up of the remote control 200 may be accomplished directly or via a computer. In one embodiment, directly programming the remote control 200 includes the user physically interacting with the remote control 200, whereas indirectly programming the remote control 200 includes the user employing a keyboard, mouse, or some other I/O device to operate the computer, which in turn transfers data to the remote control 200. The setup or configuration software is preferably in the form of a program that guides the user through setup options, enabling the user to selectively indicate the portions of the setup that are desired. As noted, one setup option preferably includes the ability to assign channels to icons, or vice-versa. The modified remote data is transferable to the remote control 200 via the docking station 106 (FIG. 1). Once transferred to the remote, the data is stored in at least one of the memories 120, 122 (FIG. 2).

Referring back to FIG. 6A, one embodiment of the invention provides that the “Wizard” and “Setup” menu items 206 are used, for example, to setup or program the remote control 200 to control desired media devices, setup an association between icons and media device channel numbers, and identify selected media device providers (e.g., TV, cable, satellite, etc.). The “Wizard” and “Setup” menu items 206 are similar, yet different in that the “Wizard” menu item 206 provides successive screens, which lead the user through an initial setup process, whereas the “Setup” menu item 206 provides similar setup screens, but allows the user more leeway to selectively setup the remote control 200.

FIG. 7A shows a method 300 for setting up a remote control. The method 300 may be accomplished through direct or indirect (i.e., via a computer) interaction with the remote control. For purposes of the present description, the method 300 is accomplished through direct interaction with the remote control after the remote control has been initially purchased or is to be used by a new user. Optionally and initially, to help orient the user with the remote control, block 302 provides that the remote control displays instructions for using particular keys or buttons.

At block 304, the remote control provides a display requesting that certain geographic reference information, such as a postal zip code, area code, or some other geographic designator, be input into the remote control. One purpose for requesting this geographic reference information is to allow the remote control to automatically identify and associate channel icons with channel numbers or to automatically provide at least one media provider within the user's geographic region. At block 306, the geographic reference information is received by the remote control. At block 308, the memory of the remote control is scanned or searched to determine if matching geographic reference information is stored in the remote control. One purpose for block 308 is to make sure that the geographic reference information was entered properly, which means that inputting a four number zip code instead of five numbers would prompt a message to re-enter the geographic reference information as provided in block 310 and sequentially illustrated in FIGS. 7B-7E.

At block 312, the remote control uses the geographic reference information to generate a menu or list of service providers, which are then displayed on the display screen of the remote control. One example of this process is shown in FIGS. 7F and 7G where the remote control prompts the user to select a television service provider that broadcasts in the geographic region that corresponds to the entered zip code. At block 314, the remote control utilizes the geographic reference information to generate a database in which media device channel numbers are paired or associated with channel icons. By way of example, the remote control constructs a database associating channel icons with local media device channel numbers (e.g., Channel 4-ABC®; Channel 5-NBC®; Channel 30-FOX®), etc.).

This form of building an icon association database is based on a memory within the remote control that contains databases for a plurality of geographic regions, including the region associated with the entered zip code. If the memory size is sufficient, this form may be preferred. Alternatively, the channel and icon database is retrieved remotely. The remote retrieval option may be preferable because it requires less memory capacity in the remote control and can allow the system to be easily updated for new channels and changed channel numbers. In this form, the remote control preferably obtains the channel and icon database from a remote server that is accessed via the computer in communication with the remote control.

FIG. 8A shows a method 400 of setting up the remote control to control a desired media device. At block 402, a display screen of the remote control permits a user to choose a type of media device to be setup for control by the remote control. At block 404, a list of brand names for the type of media device is presented for the user to select one of the brand names, if known. In other instances, additional information may be needed to identify the media device such as a model number, serial number, etc. If the brand name is not known, the user may optionally select a “try all” function on the remote control, which allows the remote control to cycle through a number of available device or setup codes in an attempt to find the code that matches the chosen type of media device. If the brand is known, the user selects that brand by pressing a corresponding peripheral button 204 according to one embodiment. FIGS. 8B and 8C provide exemplary illustrations of the display screens of the remote control in accordance with the processes described in blocks 402 and 404, respectively.

At block 406, the remote control is placed in wireless communication with the media device that is to be controlled. At block 408, the “Power” button on the remote control is pressed and released in an attempt to associate a setup or device code of the media device with the remote control, or vice-versa. At block 410, the user determines whether pressing the “Power” button turned the media device either ON or OFF, depending on its initial state. If pressing the “Power” button had no effect on the media device, then at block 412 the user continues to press the “Power” button, which results in the remote control testing other device codes that may be stored in a device code library in the remote control. If pressing the “Power” button does change the state of the media device, then at block 414 the user has the option of setting up other functions such as the “Channel +/−” function, which permits the remote control to successively step up or down through the channels of the media device. At any time during the setup method 400, the user may save settings or end the setup process as shown at block 416. Saving the setup configuration of the remote control allows the remote control to be subsequently used to control the setup features of the media device without going through additional or similar setup steps. After a first media device has been setup to be controlled by the remote control, the method 400 may be repeated for other media devices such as a cable box, DVR, DVD, CD, etc. FIGS. 8D through 8E provide exemplary illustrations of the display screen of the remote control for at least some of the above-described processes for method 400.

FIG. 9 shows a method 500 of associating channel numbers with icons in the remote control, or vice-versa. In one example of the invention, the remote is initially programmed with icons stored in a memory, but without channel assignments or other macro routines associated with those icons. A disk or other memory device accompanying the remote includes software operable by a microprocessor in order to tailor the remote in a manner desired by a particular user, for example by assigning channels to the icons. Thus, icons and channel assignment data may be preprogrammed into the remote, stored on a memory device such as a disk accompanying the remote, or accessed over a network.

For brevity, the processes of associating a channel number with an icon or associating an icon with a channel number are described alternatively and in parallel. At block 502a, a channel number of a media device is input into the remote control. In one embodiment, the channel number is input into the remote control using the numeric keypad 210 (FIG. 4A). At block 504a, an icon is displayed in response to the input channel number. As previously described, the icon may be automatically selected from a database of icons in accordance with the geographic reference information that was input into the remote control during method 300 above. For example, the remote control is capable of automatically associating channel “4” in a certain geographic region with the ABC® icon.

As an alternative to the above-described process, the icon may be selected first and then automatically paired with a channel number. Hence, at block 502b, the icon is selected from a list of icons presented on the display screen of the remote control—where the selection is done via one of the peripheral buttons 204. At block 504b, the channel number that is to be paired with the icon is displayed on the display screen. Again, the pairing of the channel number with the icon may depend on the geographic reference information (e.g., zip code) previously received by the remote control.

At block 506, the remote control provides an option for the user to revise or edit the channel number/icon pairing, if so desired. Thus, the user retains the option of associating or customizing the pairing, for example the user can assign a different icon with the channel number “4.” In one embodiment, the icons are custom-made icons that are not similar to the “official” or trademarked channel brand icons, some of which were illustrated above. Revising or editing the pairing may include assigning a different channel number to a particular icon or vice-versa. At block 508, the pairing is saved or otherwise stored in the remote control. At block 510, the remote control prompts the user to create additional pairings or end this setup feature.

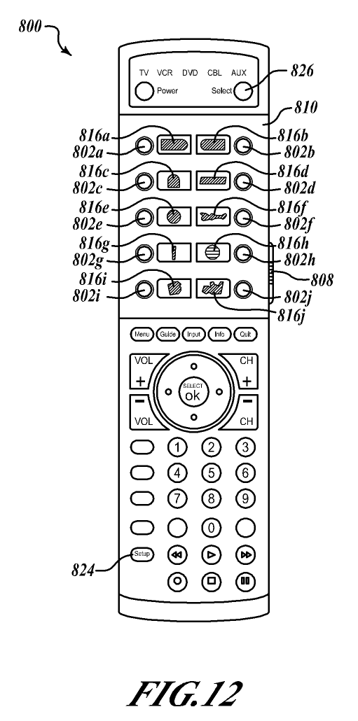

FIG. 10 shows a method 600 of setting up a protection or restriction feature, such as the “KidSafe” menu item 206 referred to in FIG. 6A according to one embodiment. At block 602, a menu item that indicates the restriction feature, menu, or module is displayed on and then selected from the display screen of the remote control using the peripheral buttons or an equivalent means. At block 604, the user enters a security code, password, or some other machine-readable data to trigger the remote control to move into a restrictive mode. The restrictive feature, when activated using the code or password, may limit or restrict certain features of the remote control such as restricting access to certain media channels, limiting how much the volume may be increased, etc. In one embodiment, the code or password is entered into the remote control using the numeric keypad 210 (FIG. 4A). At block 606, restricting access to certain media channels includes identifying a number of media channel numbers/icon pairings and selecting a number of desired pairings that will be accessible by the remote control when in the restrictive mode. At block 608, the desired pairings are matched or associated with a particular user, user group, or topical group as previously discussed above and shown in FIG. 6A. For example, the restrictive mode may be activated to limit usage by one or more children in a household when the parents are not present to supervise the children's choice of television shows. Thus by selecting the user group “Kids” shown as one of the menu items in FIG. 6B, submenus may be displayed providing the name of each child in the household—hence the remote control may be customized based on the age or gender of each child. In addition to the aforementioned aspects, each user may have their own code or password that when entered into the remote control causes the remote control to assume that user's customized setup and prevent others from modifying the setup. In such an embodiment, one user may have an administrator or owner password that may be used to override all other configurations or setup aspects of the remote control. At block 610, the user may optionally setup the remote control to be restricted or limited with regard to other features, for example the maximum volume may be limited when a particular user is using the remote control.

In another embodiment of the invention, the remote control 200 may be setup to have a universal ON/OFF feature, such as the “QuickPower” menu item referred to in FIG. 6A according to one embodiment. In one aspect, the universal power feature operates to simultaneously turn on/off multiple media devices (e.g., TV, VCR, cable, etc.)—at least those media devices that have been setup to be controlled by the remote control 200. The devices that have not been setup to be controlled by the remote control 200 may be displayed in an under-intensified, light gray, or other similar type of font on the display screen 202.

In yet another embodiment of the invention, FIG. 11 shows an exemplary method 700 where the remote control 200 is capable of communicating with a home security system. The home security system is configured to be controlled by the remote just like other devices (e.g., TV, VCR, etc.). The remote sends commands such as Arm, Disarm, etc. for the home security system instead of sending commands like On, Off, Channel Up, Volume down for a TV, or Play, Stop, Record for a VCR or DVD.

The remote control 200 includes a transceiver (e.g., 310 MHz, 433 MHz) to send or receive signals from various devices of the home security system directly or via the computer 102. At block 702, a home security device of the home security system transmits a signal in response to a condition of the home security system. The signal is received by either the remote control directly as shown in block 704 or by a computer as shown in block 706. If the latter, then block 708 indicates that the computer transmit an associated signal to the remote control. In one example of the invention, the computer 102 receives modulated radio frequency (RF) signals from a sensor of the home security system, such as an optical sensor—specifically a wireless motion sensor coupled to a door or window. In another example, the computer 102 receives electromagnetic modulated signals from a smoke alarm system of the home security system. This format may be preferable because a home personal computer may already be set up to control and monitor signals from a variety of home security devices.

After the remote control 200 receives the signal either directly from the home security device or from the personal computer, at block 710 the remote control displays a message or a security status indicator on the display screen 202, which may indicate a condition of the home security system (e.g., that a particular window or door is open). The status indicator may be in the form of a textual message, an iconic representation, or a combination of both. Optionally at block 712, the remote control 200 may be programmed to activate an audible alarm or other sound to indicate that one of the home security sensors has detected some sort of activity or condition that may have immediate security or safety implications.

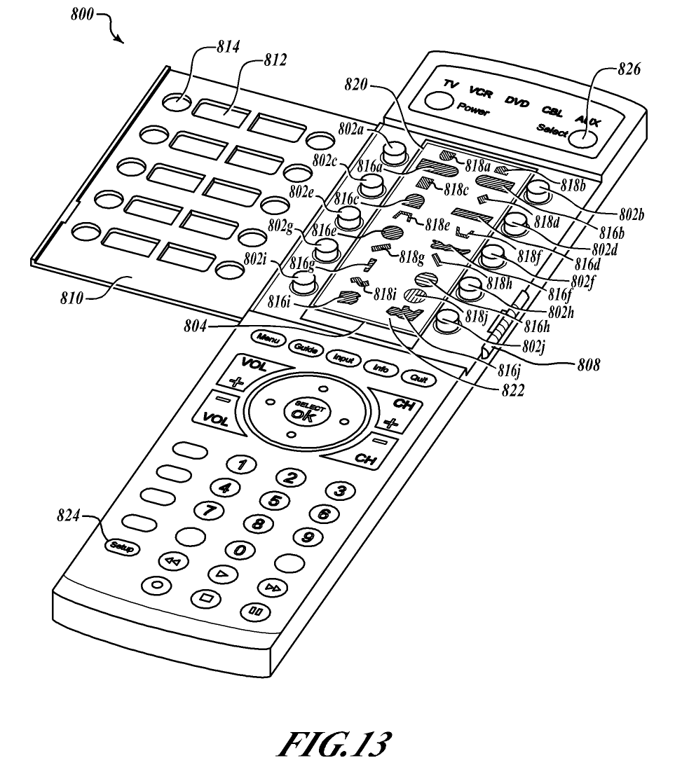

FIG. 12 is a top plan view and FIG. 13 is a perspective view of a remote control 800 formed in accordance with an embodiment of the invention. In an example embodiment, the remote control 800 includes first through tenth favorite channel buttons, labeled 802a through 802j, respectively. However, a different number or placement of favorite channel buttons may be used in other embodiments. The remote control 800 also includes an icon holding member or tray 804 with a surface positioned adjacent to the favorite channel buttons 802a through 802j. The icon holding member 804 is slidably connected to the remote control 800, and is positionable between a first position and a second position using a slide control 808 that is connected to the icon holding member 804 in such a way that a user can slide the slide control 808 and the icon holding member 804 will move. In one embodiment, the icon holding member 804 and the slide control 808 are different portions of a single integral component. However, in other embodiments, the icon holding member 804 and the slide control 808 are separate parts.

In one embodiment, the remote control 800 includes an icon holding member cover 810. The icon holding member cover 810 is shown in a closed position in FIG. 12 and in an open position in FIG. 13. In one embodiment, the icon holding member cover 810 is connected to the remote control 800 with a hinge (not shown) that allows the icon holding member cover 810 to be opened and closed while remaining attached to the remote control 800. However, in other embodiments, the icon holding member cover is connected to the remote control 800 in other ways, and may also be removably connected to the remote control 800. The icon holding member cover 810 is shown with a plurality of icon viewing portions 812 that allow a user of the remote control 800 to view icons located on the icon holding member 804 when the icon holding member cover 810 is closed. In one embodiment, the icon viewing portions 812 are formed of a non-opaque material such as a transparent or translucent polymer material. However, in other embodiments, the icon viewing portions are simply shaped holes formed by the surrounding portions of the icon holding member cover 810. In the example shown, the icon holding member cover 810 also includes a plurality of favorite channel button pass-through holes 814 formed by surrounding portions of the icon holding member cover 810 that allow the favorite channel buttons 802a through 802j to pass through the icon holding member cover 810 when the cover 810 is placed in the closed position. However, in other embodiments, the cover 810 may be structured to cover only the icon holding member 804 in such a way that the favorite channel button pass-through holes 814 are not needed. In still other embodiments, the icon holding member cover 810 may not be included.

In the example shown, a first set of icons, designated as 816a through 816j are located adjacent to the favorite channel buttons 802a through 802j, respectively when the icon holding member 804 is in the first position. A second set of icons, designated as 818a through 818j are located adjacent to the favorite channel buttons 802a through 802j, respectively when the icon holding member 804 is in the second position. The icon holding member cover 810 is structured in such a way that when closed, the set of icons that is currently adjacent to the favorite channel buttons 802a through 802j is visible through the icon viewing portions 812. In the example shown, only the set of icons that is currently adjacent to the favorite channel buttons 802a through 802j is visible, while the other set is blocked from view by other portions of the icon holding member cover 810. This results in the first set of icons 816a through 816j being visible when the icon holding member 804 is in the first position, as shown in FIG. 12. When a user switches the icon holding member to the second position, the second set of icons 818a through 818j is visible through the icon viewing portions 812 rather than the first set of icons 816a through 816j. During the transition from the first position to the second position, portions of both the first set of icons 816a through 816j and the second set of icons 818a through 818j may be visible. Although the icon holding member 804 has two icon viewing positions in the example shown in FIGS. 12 and 13, the icon holding member 804 may be positionable in additional viewing positions that allow a corresponding number of additional sets of icons to be used in association with the favorite channel buttons 802a through 802j in other embodiments.

In an example embodiment, the remote control 800 is structured similarly to the remote control 104 described with respect to FIG. 2, except that the remote control 800 does not include a display device in the example shown in FIGS. 12 and 13. However, in one example, the remote control 800 includes memory, a microprocessor, a transmitter, and an I/O interface that are structured, connected, and function in similar fashion to that described with respect to FIG. 2. Additionally, the remote control 800 interacts with media devices and electronic components in similar fashion to that described with respect to FIG. 3. The I/O interface is a user interface that includes the favorite channel buttons 802a through 802j as well as other interface buttons. In addition, in one example, the icon holding member 810 is connected to the I/O interface in such a way that the position of the icon holding member 810 is communicated to the microprocessor. In other embodiments, the slide control 808 rather than the icon holding member is connected to the I/O interface. This allows the remote control 800 to properly store and retrieve favorite channels for each position of the icon holding member 810 in similar fashion to that described with respect to FIG. 6B, but without use of a display screen in one example. This allows a his/hers configuration similar to that described with respect to FIG. 6B with the two primary positions of the slide control 808 taking the place of the his and hers buttons, or may be used for any other favorite channel division desired by users of the remote control 800, such as parents/children, or simply a first set of favorites and an additional set of favorites.

In one example, the icon holding member 804 includes a lip on at least one edge, and is preferably formed as a tray with a lip 820 around the perimeter of the icon holding member 804 that extends upward from the surface of member 804 adjacent to the favorite channel buttons 802a through 802j toward the icon holding member cover 810 when it is in the closed position. Typically, the first set of icons 816a through 816j and the second set of icons 818a through 818j are printed onto a sheet of paper 822 or a card sized to fit the member 804. Alternatively, the icons are labels that are attached to a card or piece of paper sized to fit the member 804. Any of the icons 816a through 816j and 818a through 818j may not be present if a user chooses to not use all of the favorite channel buttons. Additionally, some of the icons may be duplicated, depending on the desired favorite channels of the user. In some embodiments, the sheet of icons 822 simply rests on the icon holding member 804, but in other embodiments, the sheet of icons 822 may be attached to the icon holding member 804 using a suitable adhesive, or may be held in place with a clip. In embodiments where the lip 820 is present, the lip 820 holds the sheet of icons 822 or other material on which icons are located in place such that when the icon holding member 804 is moved from the first position to the second position, the sheet of icons 822 does not move relative to the surface of the icon holding member 804.

The icons 816a through 816j and 818a through 818j are illustrated as generic shapes. However, in one example, the generic shapes represent actual logos and brands, which may be in various forms such as text, image, or a combination of both. By way of example, the actual logos may be trademarks of a particular media distributor (e.g., ABC®, CNN®, HBO®, FOX®, etc.). Thus, once the remote has been programmed to associate an icon with a channel when the icon holding member 804 is in the first or second position, depressing the appropriate favorite channel button 802a through 802j adjacent to the icon when the icon holding member 804 is in the same position will cause the channel to change to the channel associated with the icon. Programming instructions stored in the remote control's 800 memory are associated with each icon. For icons indicative of a television channel, the memory stores data sufficient to cause the remote control to send a signal to the television to change to the channel represented by the icon. Other icons may represent aspects other than channels, and instructions stored in the memory reflect the function desired to be carried by the icons. For example, depressing the favorite channel button 802a adjacent to the icon 816a will change the television channel to whatever channel is assigned to the icon 816a. In similar fashion, if the remote has further macro programming assigned to the icon, pressing the favorite channel button associated with the icon causes the remote to carry out the macro instructions assigned to the icon.

In some example embodiments, the remote control 800 includes favorite channel up and favorite channel down functionality that is implemented in similar fashion to that described with respect to the remote control 200. The remote control 800 includes a dedicated favorite channel down button, such as the button to the left of the zero button, and a dedicated favorite channel up button, such as the button to the right of the zero button, in some embodiments. Preferably, the favorite channel up button and the favorite channel down button cycle through the favorite channels for each user in the same order that the corresponding icons for each user are positioned on the icon holding member 804.

In one example, the remote control 800 is configured as follows. First, at least one icon is placed on the icon holding member 804 adjacent to one of the favorite channel buttons. Next, the remote control 800 is programmed to send a signal representing a desired channel that corresponds to the icon using a transmitter within the remote control 800 when the favorite channel button adjacent to the icon is pressed. In one example, the remote control 800 is programmed by pressing and holding a setup button 824 for a predetermined period of time, such as approximately three seconds. Then, the favorite channel button to be programmed is pressed. Next, an electronic device, such as a media device, is selected by pressing a select button 826 on the user interface of the remote 800. In one example, the select button 826 causes different media device possibilities, such as TV, VCR, DVD, cable (CBL) or auxiliary (AUX) to be indicated on the remote 800 each time the select button 826 is pressed. Then, a channel number corresponding to the icon next to the favorite channel button being programmed is entered using a keypad on the remote. In one example, a select/ok button is pressed after the channel number has been entered. In embodiments having an icon holding member 804 that can be positioned in more than one location, configuring the remote 800 also includes positioning the icon holding member 804 in one of the two selectable positions before the favorite channel button to be programmed is pressed. After one favorite channel button has been programmed, additional favorite channel buttons may be programmed by pressing an additional favorite channel button and entering an additional channel number that corresponds to an additional icon located adjacent to the additional favorite channel button. Although configuration of the remote control 800 has been described with respect to one example, it should be understood that the operations may take place in a different order and that some steps may not always be necessary such as if the currently selected media device is the desired one, selecting a media device is not required. Additionally, other methods of configuring the remote control 800 that use different buttons or different ordering in the pressing of buttons to program the remote control 800 may also be used so long as they associate a signal to be transmitted from the remote control 800 with the pressing of at least one of the favorite channel buttons 802a through 802j.

Many other changes can be made in light of the above detailed description. In general, in the following claims, the terms used should not be construed to limit the invention to the specific embodiments disclosed in the specification and the claims, but should be construed to include all types of remote controls, computers, and data communication means that operate in accordance with the claims. Accordingly, the invention is not limited by the disclosure, but instead its scope is to be determined entirely by the following claims.

What is claimed is:

1. A remote control comprising:
a microprocessor;
a user interface in signal communication with the microprocessor;
a transmitter controlled by the microprocessor and configured to transmit a wireless signal from the remote control; and
a memory accessible by the microprocessor, the memory containing:
a database of a plurality of favorite channels, the favorite channels being a subset of all available channels for a media device; and
a set of stored programming instructions that cause the remote, responsive to user activation of the user interface, to send a signal from the transmitter sufficient to cause a channel of the media device to change to at least one of a next successive favorite channel or a previous successive favorite channel.

2. The remote control of claim 1, wherein the user interface comprises a favorite channel up button and a favorite channel down button.

3. The remote control of claim 2, further comprising a display screen in signal communication with the microprocessor, wherein activation of the next favorite channel button causes an icon corresponding to the next favorite channel to appear on the display screen, and wherein activation of the previous favorite channel button causes an icon corresponding to the previous favorite channel to appear on the display screen.

4. The remote control of claim 2, wherein the next favorite channel after the last channel in the stored database is the first channel in the stored database, and wherein the previous favorite channel before the first channel in the stored database is the last channel in the stored database.

5. The remote control of claim 2, further comprising:
a plurality of favorite channel buttons in signal communication with the microprocessor, wherein pressing the favorite channel buttons causes the microprocessor to operate programming instructions stored in memory; and
an icon holding member having at least one surface positioned adjacent to at least one of the favorite channel buttons such that a first icon corresponding to a first channel of the media device may be placed on the surface adjacent to a first button when the icon holding member is in a first position,
wherein the transmitter is also controlled by the microprocessor to transmit a wireless signal from the remote control in response to the operation of the stored programming instructions caused by pressing the favorite channel buttons, the signal including information to change the channel of the media device to the channel represented by the first icon on the surface adjacent to the pressed first favorite channel button when the icon holding member is in the first position.

6. The remote control of claim 5, wherein the favorite channel up button and the favorite channel down button cycle through the favorite channels in the same order in which their corresponding icons are positioned on the icon holding member.

7. The remote control of claim 2, wherein the remote control is a mobile phone.

8. The remote control of claim 2, wherein the database of stored favorite channels includes favorite video channels for display on a television.

9. The remote control of claim 1, wherein the user interface includes a first multipurpose button configured as a favorite channel up button and a second multipurpose button configured as a favorite channel down button.

10. The remote control of claim 9, wherein the first multipurpose button is a channel up button that cycles up through all channels when not otherwise configured, and wherein the second multipurpose button is a channel down button that cycles down through all channels when not otherwise configured.

11. The remote control of claim 9, further comprising:
a display screen configured to display an icon, the icon corresponding to a media channel of the media device; and
a screen interface that allows a selection of the icon, wherein the selection of the icon causes the microprocessor to operate programming instructions stored in the memory,
wherein the transmitter is also controlled by the processor to transmit a wireless signal from the remote control in response to the operation of the stored programming instructions caused by selection of the icon with the screen interface, the signal containing information to change the channel of the media device to the channel represented by the selected icon.

12. The remote control of claim 11, wherein the first multipurpose button is a channel up button that cycles up through all channels when not otherwise configured, and wherein the second multipurpose button is a channel down button that cycles down through all channels when not otherwise configured.

13. The remote control of claim 1, wherein the user interface comprises a touch screen.

14. A method of using a remote control with a media device comprising: providing a remote control comprising:
a microprocessor;
a user interface in signal communication with the microprocessor;
a transmitter controlled by the microprocessor and configured to transmit a wireless signal from the remote control; and
a memory accessible by the microprocessor, the memory containing:
a database of a plurality of favorite channels, the channels being a subset of all available channels for a media device; and
a set of stored programming instructions that cause the remote, responsive to user activation of the user interface, to send a signal from the transmitter sufficient to cause a channel of the media device to change to a next successive favorite channel; and
activating the user interface to select a next favorite channel.
